(19) United States
(12) Patent Application Publication
(10) Pub. No.: US 2005/0177511 A1
(43) Pub. Date: Aug. 11, 2005

(54) Detailed data provision system

(76) Inventors: Koushi Sakaguchi, Amagasaki-shi (JP); Tadao Ishimi, Osaka (JP)

Correspondence Address: MCDERMOTT WILL & EMERY LLP, 600 13TH STREET, N.W., WASHINGTON, DC, 20005-3096, US

(21) Appl. No.: 10/985,035

(22) Filed: Nov. 10, 2004

(30) Foreign Application Priority Data
Nov. 11, 2003 (JP) 2003-380943

(51) Int. Cl. G06F 17/60

(52) U.S. Cl. 705/44

(57) ABSTRACT

A detailed data provision system that makes it easy for a recipient who receives basic data provided from an intermediary to reference detailed data corresponding to the basic data, while at the same time maintains confidentiality of the detailed data. Transmission result data that contains the ID code of the basic data, as well as address data and verification data correlated with the ID code, is sent to an apparatus of the intermediary. When there is an access request to access the address where detailed data is stored, whether or not to authorize access of the detailed data is determined based on the ID code and verification data correlated with the address.

### BACKGROUND OF THE INVENTION

1. Field of the Invention

This invention relates to a detailed data provision system and more particularly to providing a remittee details about remittance information sent to the bank in which the remittee has an account.

2. Description of the Related Art

There are standard protocols or services for exchanging data between banks, such as one by the Japanese Bankers Association between banks in Japan and one by SWIFT (Society for Worldwide Interbank Financial Telecommunications) between international banks. When a company sends money to an overseas party, the account bank requested by the company sends electronic remittance data to the account bank of the remittee via a SWIFT network. In the SWIFT service, to identify banks in the various countries, a unique SWIFT code is assigned to each bank. The electronic remittance data contains the code for the account bank of the remitter and the remittance number at the bank, the code for the account bank of the remittee, and the account number at the bank of the remittee. The account bank of the remittee that receives this electronic data performs processing to deposit money into the account of the remittee based on the data.

Japanese unexamined patent publication No. 2002-83141 or No. 2003-6443 discloses a method for remittance using the protocol by the Japanese Bankers Association. As disclosed in these publications, a format is given to the data exchanged between banks.

The format has various items normally required. However, it may be necessary to exchange more information related to the remittance in addition to those items, in order to perform work smoothly at the remitter and the remittee. After a company, which receives various orders from divisions of an ordering company, sends a invoice to the ordering company in exchange for delivery of the ordered product, if the company receiving the order makes a deposit inquiry with the account bank, the company cannot quickly check for which invoice the deposit is for, even though it can confirm that there is a deposit from the ordering company. In this case, when the remittance is made, the person in charge at the remitter uses a facsimile or a telex to separately send a remittance advice to the remittee. The advice includes details of the remittance using the invoice number, the code of the division making the remittance, and the management number of the company. When the company receives an inquiry about detailed information from the remitter after sending the remittance advice, the company asks the details to the individual division making the remittance to reply to the inquiry.

### SUMMARY OF THE INVENTION

It takes a lot of time to separately send remittance advices or answer inquiries. Also, from the standpoint of the remittee, the remittee is hindered from the fast and effective collection of payment, because the person in charge needs to transfer the facsimiles and telexes from the remitters to the appropriate department to check the details.

Instead of facsimiles or telexes, it is possible to send electronic data including detailed information about the remittance to the remittee from the remitter via a network, however in that case it becomes necessary for the person in charge at the remittee to compare the contents of the deposit inquiry with the detailed data received.

Furthermore, in the case of sending detailed information with electronic data via a network, due to the nature of electronic data, the high necessity for confidentiality from parties other than the remitter and remittee must be considered.

These kinds of problems occur in other cases where the detailed data is provided separately from the basic data provided by an intermediary like the account bank of the remittee.

Taking the problems with the prior art into consideration, the object of this invention is to provide a detailed data provision system with which a person receiving basic data provided from an intermediary can check the detailed data corresponding to the basic data, as well as maintain confidentiality of the detailed data.

In order to accomplish the above object, the detailed data provision system of this invention includes a detailed data provision apparatus. The detailed data provision apparatus provides detailed data of basic data to a terminal of a recipient. The basic data is sent to an apparatus of an intermediary. The apparatus of the intermediary provides data corresponding to the basic data to the terminal of the recipient. The detailed data provision apparatus comprises the following units.

In this detailed data provision apparatus, a storing unit stores the detailed data. A correlation unit correlates the ID code of the basic data, address data indicating the address of the detailed data corresponding to the basic data, and verification data for verifying an access source accessing the detailed data. A communication unit sends transmission result data, which includes the ID data of the basic data, as well as, address data and verification data that are correlated with the ID code, to the apparatus of the intermediary receiving the basic data. Receiving a request to access the address of the stored detailed data, a judgment unit determines whether or not to authorize access of the detailed data according to the ID code and verification data that are correlated with the address. A provision unit provides detailed data for which access is authorized to a source of the request.

In the apparatus of the intermediary, a storing unit stored providing data corresponding to the basic data. When the providing data corresponding to the ID code included in the received transmission result data is stored, a correlation unit correlates the transmission result data with the providing data. Receiving a connection request from a terminal, a verification unit verifies a user of the terminal. When receiving a request from the terminal of the verified user, if the transmission result data is correlated with the data provided to the terminal in correspondence to the request, a creation unit creates data for accessing the address indicated by the address data based on the ID code, address data and verification data that are included in the transmission result data, and adds the created data to the data to be provided according to the request.

In case of providing details to the remittee about the remittance information sent to the account bank of the remittee, the basic data is data related to a remittance. The transmission result data is remittance result data that includes a remittance ID code, as well as address data and verification data that are correlated with the ID code. The detailed data provision apparatus is an apparatus at the remitter. The terminal of the recipient is a terminal of a remittee. The apparatus of the intermediary is an apparatus at the account bank of the remittee.

In this case, in addition to the remittance ID code and the address data and verification data correlated with the ID code, the remittance result data may include the ID code of the account bank of the remitter, the ID code of the account bank of the remittee and the account number at the account bank of the remittee. When deposit data is stored that corresponds to the remittance ID code, ID code of the account bank of the remitter, ID code of the account bank of the remittee, and account number at the account bank of the remittee that are included in the received remittance result data, the bank apparatus can correlate the remittance ID number, address data and verification data included in the remittance result data with the deposit data.

In the detailed data provision system of this invention, transmission result data is sent to the apparatus of an intermediary. The terminal of the recipient, which receives the provided data corresponding to the basic data from the apparatus of the intermediary, can easily access corresponding detailed data by using the address data included in the transmission result data. Moreover, when receiving an access request to access the address of stored detailed data, the detailed data provision apparatus authorizes access to the detailed data based on the ID code and verification data that are correlated with the address. Therefore, it is possible to maintain confidentiality of the detailed data. Particularly, when the apparatus of the intermediary performs the verification, only the person that received the verification can use the remittance result data, so it is possible to maintain even more strict confidentiality.

From another aspect, this invention also provides a method for providing detailed data of basic data sent to the apparatus of the intermediary to a terminal of a recipient. The apparatus of the intermediary provides data corresponding to the basic data.

The detailed data provision method comprises the steps of: correlating an ID code of the basic data, address data indicating an address of the detailed data that corresponds to the basic data, and verification data for verifying an access source accessing that detailed data; sending transmission result data, which includes the ID code of the basic data as well as the address data and verification data that are correlated with the ID code, to the apparatus of the intermediary that receives the basic data; in response to a request to access an address of stored detailed data, determining whether or not to authorize access of the detailed data based on the ID code and verification data correlated with the address; and providing detailed data for which access is authorized to a source of the request.

From yet another aspect, this invention provides a computer readable medium bearing a program for causing a computer to execute the above steps.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 illustrates the basic construction of the detailed data provision system in the embodiment.

FIG. 2 is a block diagram illustrating the functions of the detailed data provision system in the embodiment.

FIG. 3 illustrates the basic construction of the computer at the remitter.

FIG. 4 is a flowchart for explaining the procedure executed on a computer according to a detailed remittance data provision program.

FIG. 5 is another flowchart for explaining the procedure executed on a computer according to a detailed remittance data provision program.

FIG. 6 illustrates the detailed data.

FIG. 7 illustrates the basic construction of the computer at the account bank of the remittee.

FIG. 8 is a flowchart for explaining the procedure executed on a computer according to an inquiry program.

FIG. 9 is another flowchart for explaining the procedure executed on a computer according to an inquiry program.

FIGS. 10A and 10B illustrates a deposit and withdrawal database for each account.

FIG. 11 illustrates an example of a login form displayed by the web browser at the terminal used by the person performing the transaction at the account bank of the remittee.

FIG. 12 illustrates an example of the account number input form displayed by the web browser at the terminal used by the person performing the transaction at the account bank of the remittee.

FIG. 13 illustrates an example of the webpage source to which the remittance result data is added.

FIG. 14 illustrates an example of an inquiry result page displayed by the web browser at the terminal used by the person performing the transaction at the account bank of the remittee.

FIG. 15 illustrates an example of a page including the detailed data.

### DESCRIPTION OF THE PREFERRED EMBODIMENTS

In this embodiment, the invention is embodied as a detailed remittance data provision system that comprises a detailed remittance data provision apparatus that provides detailed data related to a remittance to a terminal of the remittee that receives deposit data from an apparatus at the account bank of the remittee corresponding to the data related to the remittance sent to the apparatus at the account bank.

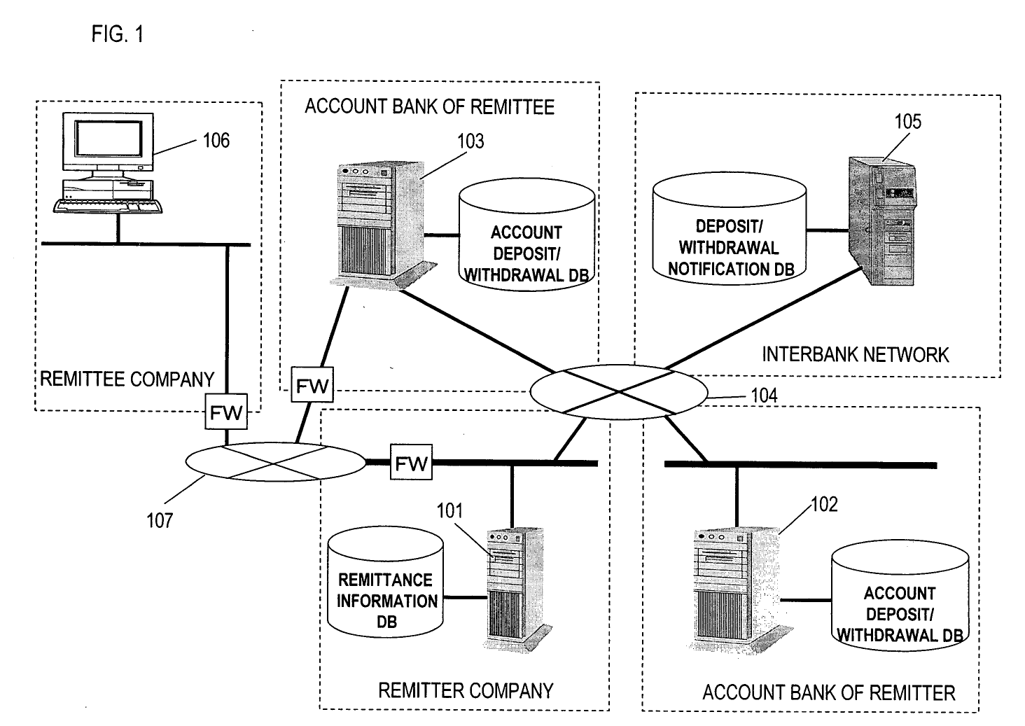

As shown in FIG. 1, in the detailed remittance data provision system of this embodiment, the computer 101 of the remitter company, the computer 102 of the account bank of the remitter company, and the computer 103 of the account bank of the remittee company are connected by way of a public line or dedicated line 104. The public line or dedicated line 104 is used for forming an EDI (Electric Data Interchange) transmission system to exchange electronic data between businesses, or for connecting the bank computers 102 and 103 to the Japanese Bankers Association network or SWIFT network 105.

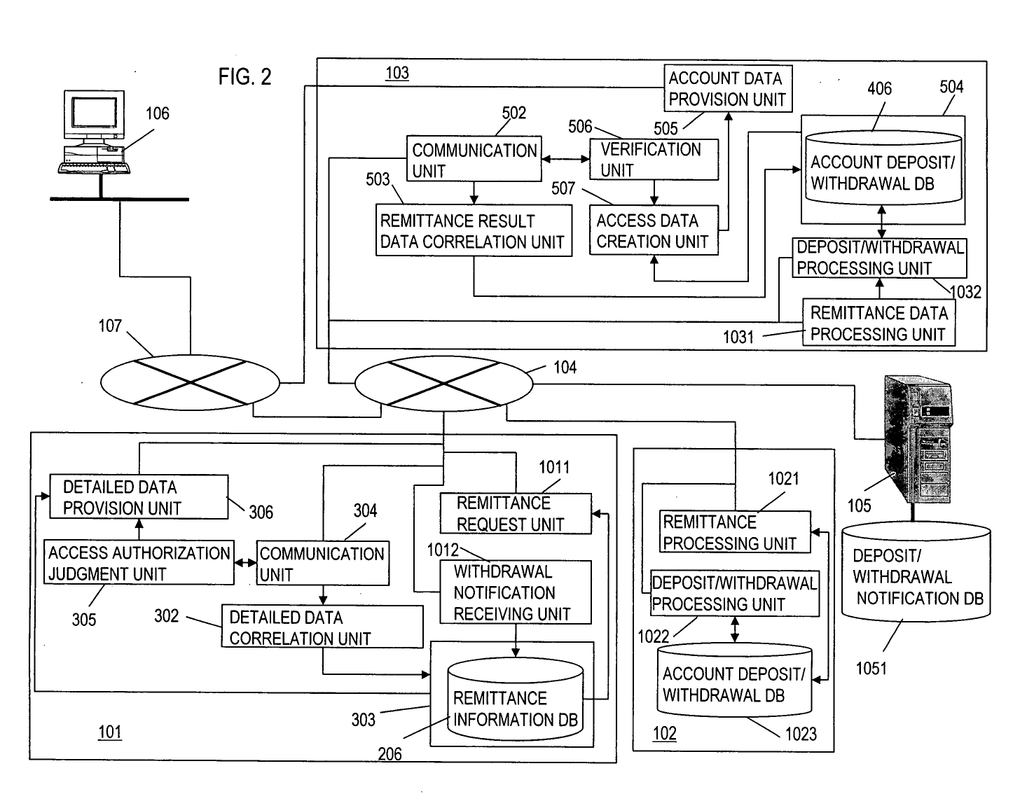

By running programs on the respective computers 101 to 103, it is possible to process remittances, as well as deposits and withdrawals. The computer 101 operates according to instructions of the program, and as shown in FIG. 2, it comprises: a remittance request unit 1011, withdrawal notification receiving unit 1012 and remittance information database 206; and the computer 102 comprises: a remittance processing unit 1021, a deposit/withdrawal processing unit 1022 and account deposit/withdrawal database 1023. Furthermore, the computer 103 comprises: a remittance data processing unit 1031, a deposit/withdrawal processing unit 1032 and an account deposit/withdrawal database 406.

The company of the remitter has various business domain companies such as subsidiary companies, internal divisional companies and the like. The company of the remittee delivers ordered products according to orders from a plurality of the domain companies, and sends invoices for the costs to the company of the remitter. The company of the remitter performs a remittance for an invoice. When performing a remittance, electronic data requesting the remittance is sent from the computer 101 of the remitter to the computer 102 at the account bank of the remitter by way of the EDI system.

Electronic data such as the remitter, remittance date and amount are stored in the remittance information database 206 of the computer 101 as remittance information. The remittance request unit 1011 reads the remittance information from the remittance information database 206, and performs processing for sending a remittance request to the computer 102 based on the read remittance information.

On the computer 102 of the account bank of the remitter, when a remittance request is received, the remittance processing unit 1021 performs the remittance processing by assigning a remittance number to a remittance to identify the remittance. According to the format set in the protocol by the Japanese Bankers Association or the SWIFT service, the remittance processing unit 1021 creates electronic data for the remittance from the remittance request data and assigned remittance number, and sends the created data to the computer 103 at the account bank of the remittee via a network 105. The computer located on the network uses a deposit/withdrawal notification database 1051 to mediate communication between the computer 102 and computer 103.

On the computer 103 at the account bank of the remittee, the remittance data processing unit 1031 receives and processes the electronic remittance data. Based on the processing result, the deposit/withdrawal processing unit 1032 processes a deposit to the account of the specified remittee. The deposit/withdrawal processing unit 1032 updates the data for the specified account from among the data for each account stored in the account deposit/withdrawal database 406, based on the processing result from the remittance data processing unit 1031.

After processing the deposit by the computer 103 at the account bank of the remittee, the deposit/withdrawal processing unit 1032 notifies the computer 102 via the network 105 that the deposit has been completed. When the computer 102 at the account bank of the remitter receives the notification, the deposit/withdrawal processing unit 1022 process the withdrawal for the corresponding account data from among the account data stored in the account deposit/withdrawal database 1023. Also, the deposit/withdrawal-processing unit 1022 sends a notification to the computer 101 at the remitter that a withdrawal has been made from the account of the remitter. This notification contains the remittance number assigned by the account bank of the remitter.

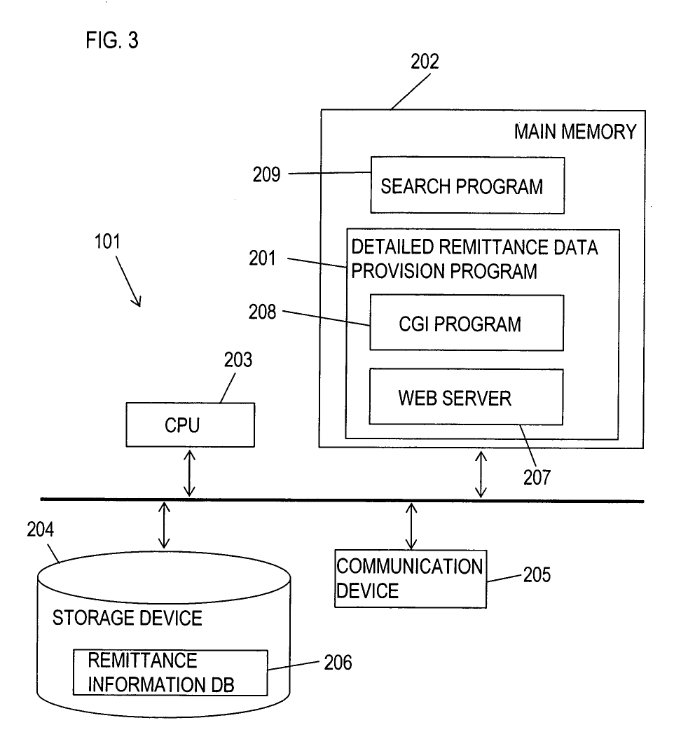

In this embodiment, after the remittance and deposit have been performed in this way and the withdrawal notification receiving unit 1012 of the computer 101 of the remitter receives a withdrawal notification, the detailed remittance data provision program for providing detailed remittance data to the remittee for the remittance operates on the computer 101 of the remitter. As shown in FIG. 3, during operation, part or all of the detailed remittance data provision program 201 is read into the main memory 202 of the computer 101.

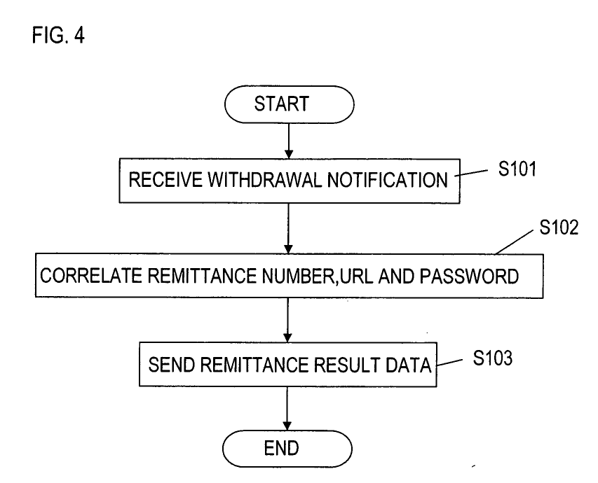

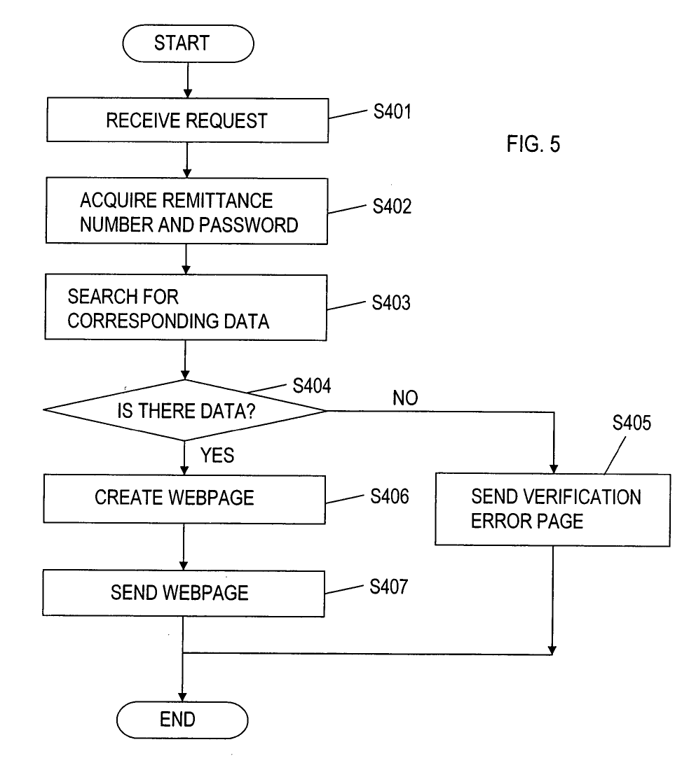

This program 201 works together with hardware resources such as the memory 202, CPU (Central Processing Unit) 203, storage device 204, communication device 205 of the computer 101, and the like, and causes the computer 101 to function as the detailed data provision apparatus of this invention, and causes the CPU 203 of the computer 101 to execute a method comprising the steps shown in FIG. 4 and FIG. 5.

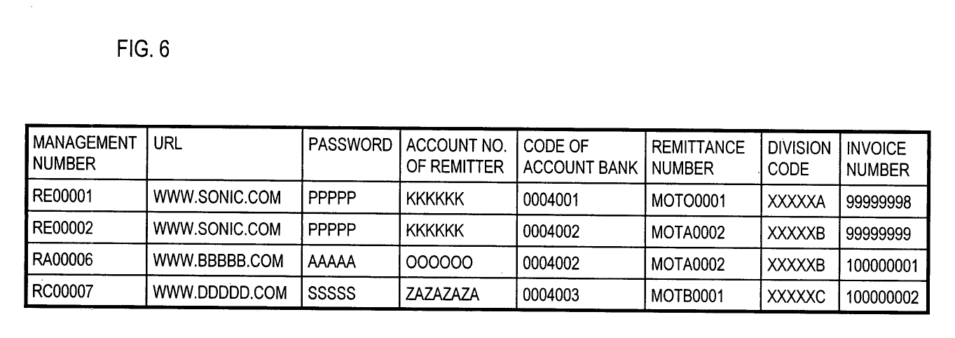

By following the instructions from the program 201, as shown in FIG. 2, the computer 101 has a detailed data correlation unit 302 as well as other units, in addition to the remittance request unit 1011, deposit/withdrawal notification receiving unit 1012 and remittance information database 206. After receiving withdrawal notification data, the detailed data correlation unit 302 correlates the address data, which expresses the address of the detailed data corresponding with the remittance, and the verification data for verifying the source accessing the detailed data, with the remittance ID code. Here, the remittance ID code is the remittance number contained in the withdrawal notification data. The detailed data is stored for each remittance in the storing unit 303. It is the original data when requesting the remittance, and not only is it the data sent to the account bank of the remittee, but as shown in FIG. 6, it contains the management number of the remitter and the division code for the domain company, as well as the invoice number.

Each record of the detailed data also contains a URL (Uniform Resource Locator) and password. The URL is an example of the address for the detailed data. The program 201 includes a web server 207, and http (hyper text transfer protocol) or https (hyper text transfer protocol security) is specified as the scheme for this URL. This URL is used to specify the location of HTML (Hyper Text Markup Language) documents, as well as a CGI (Common Gateway Interface) program 208 contained in the program 201 and the arguments given to it. The web server 207 sends appropriate messages to the web server of the requesting source according to the URL.

The password is an example of the verification data. When the web server 207 receives a request for a resource that is specified by the corresponding URL, the web server uses the password for verification.

In the case where the storage device 204 of the computer 101 is used as the storing unit 303, when withdrawal notification data is received by the communication device 205 (S101 in FIG. 4), the program 201 extracts the management number from the withdrawal notification data, and searches the remittance information database 206 in the storage device 204 for the record of detailed data corresponding to the extracted management number. The communication device 205 is an NIC (Network Interface Card), modem or DSU (Data Service Unit), for example. When a corresponding record is found, the program 201 adds the remittance number extracted from the withdrawal notification data to the record (S102). Each record contains a URL and password, so by adding a remittance number, it is possible to correlate the remittance number with the URL and password.

When an ID code is assigned to the remittance, the communication unit 304 sends the remittance result data, which includes the ID code as well as the address data and verification data that are correlated with the ID code, to the account bank of the remittee. Here, after the remittance number, URL and password have been correlated, the communication unit 304 immediately, or at an appropriate time, sends the remittance result data containing them. It is possible to use the communication device 205 of the computer 101, or the communication function of the OS (Operating System) that operates on the computer 101 as the communication unit 304. When performing this process, the program 201 extracts the remittance number of the record for which there is a withdrawal notification, together with the URL and password that are correlated with the remittance number, from the database 206 to create remittance result data, and by the communication device 205, sends the remittance result data via a public line or dedicated line 104 (S103). In this embodiment, in addition to the remittance number, URL and password, the remittance result data includes the ID code of the account bank of the remitter, the ID code of the account bank of the remittee and the account number at the account bank of the remittee. The remittance result data can be sent directly from the computer 101 of the remitter to the computer 103 at the account bank of the remittee, or can be sent via the existing network such as the network of the Japanese Bankers Association or SWIFT network. In the case of sending the remittance result data via the existing network, it may be necessary to expand the protocol, however, if the protocol is expanded to be able to exchange the kinds of data described above, it is not necessary to perform various expansions according to the type of work or business of the company of the remitter.

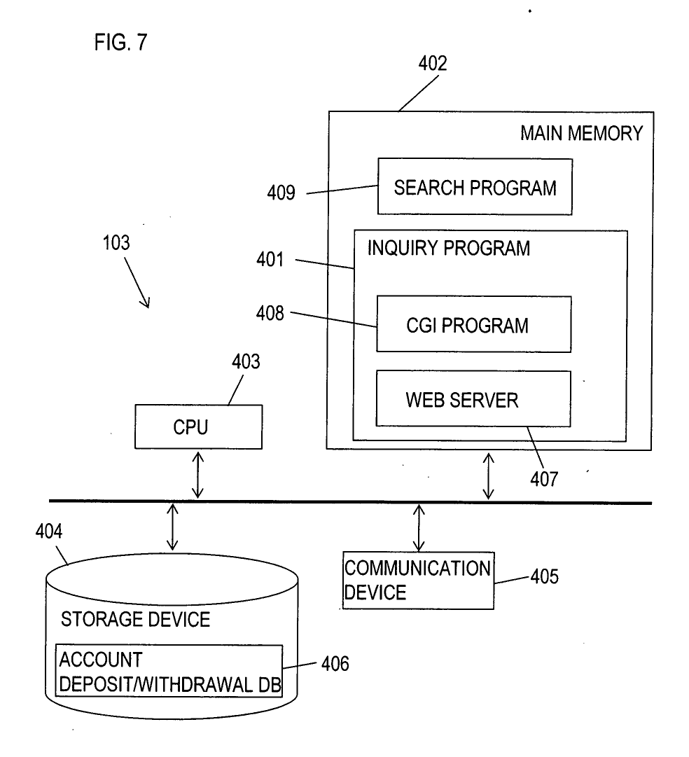

In this embodiment, an inquiry program for disclosing the contents of the account for which there is an inquiry from the customer of the bank operates on the computer 103 of the remitter to which the remittance result data is sent. Here, the inquiry program not only discloses the account contents, but also performs preparation for doing so. As shown in FIG. 7, during operation, all or part of the inquiry program 401 is read to the main memory 402 of the computer 103.

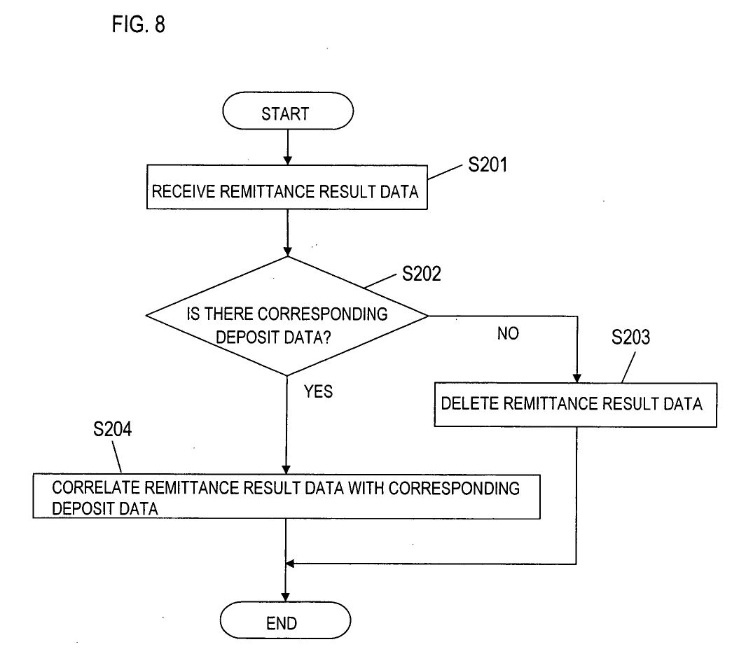

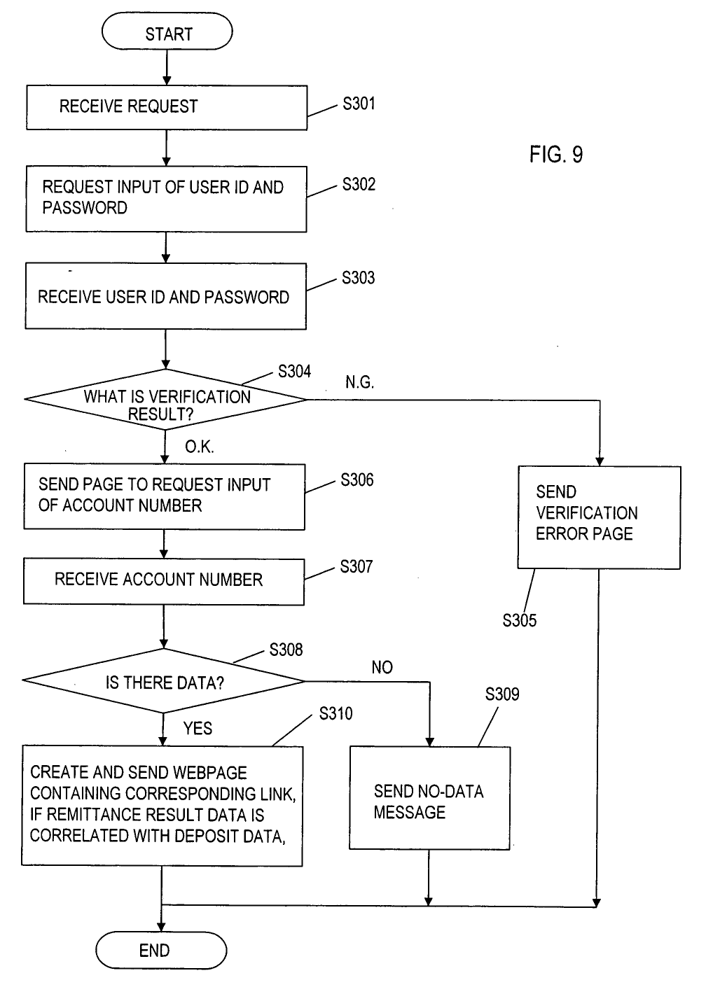

This program 401 works together with hardware resources such as the memory 402, CPU 403, the storage device 404, communication device 405 of the computer 103, and the like, to make the computer 103 function as the bank apparatus of this invention, and causes the CPU 403 of the computer 103 to execute a method comprising the steps as shown in FIG. 8 and FIG. 9. The storage device 404 is a hard disk drive or the like; and similar to the communication device 205, the communication device 405 is an NIC, modem, DSU, or the like.

By following instructions from the program 401, as shown in FIG. 2, the computer 103 has a communication unit 502 and other units, in addition to the remittance data processing unit 1031, deposit/withdrawal processing unit 1032 and account deposit/withdrawal database 406. The communication device 405 of the computer 103 or the communication function of the OS that operates on the computer 103 can be used as this communication unit 502. The computer 101 and computer 103 are logically connected by way of the communication units 502 and 304, and the communication unit 502 receives remittance result data from the computer 101 (S201 in FIG. 8).

After receiving remittance result data, the remittance result data correlation unit 503 correlates the remittance result data with the deposit data if there is deposit data stored corresponding to the remittance result data. Data that gives the contents of the account of the customer is stored in the storing unit 504 for each account. The account contents are contents indicating deposits and withdrawals. The deposit data corresponding to the remittance from the company of the remitter becomes included in the account data of the company of the remittee. In addition to the amount and name of the remittee, the remittance number and code for the account bank of the remittee are also included in the deposit data.

When the storage device 404 of the computer 103 is used for the storing unit 504, the program 401 searches the account deposit/withdrawal database 406 in the storage device 404 for the record of the deposit data that corresponds to the received remittance result data.

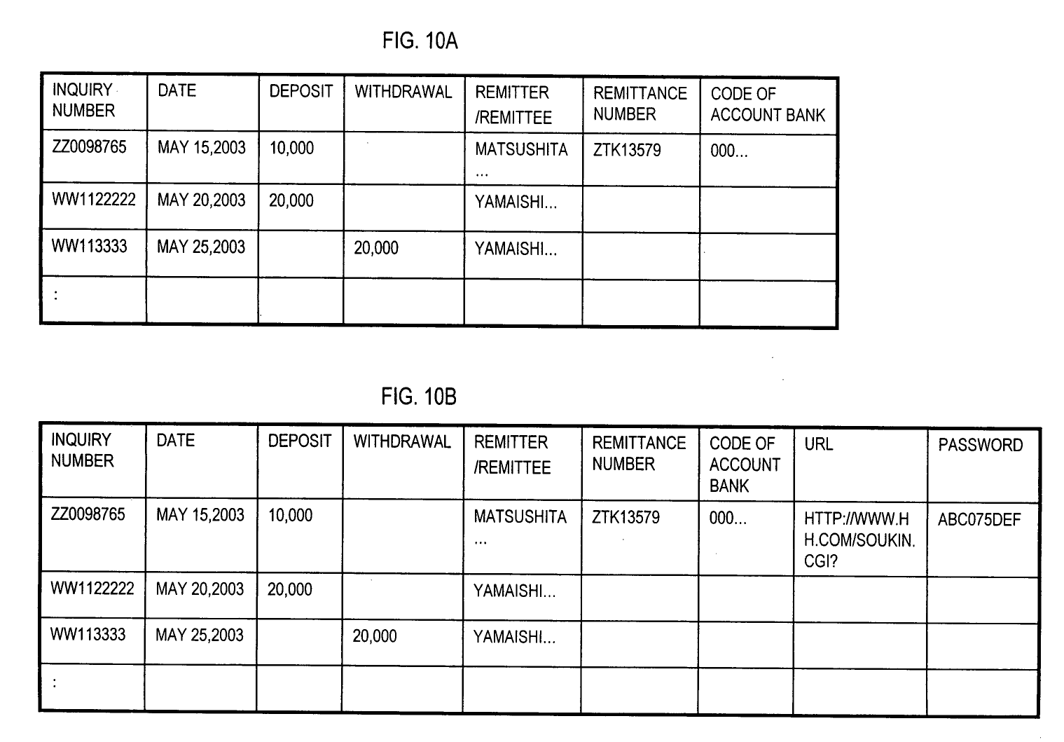

FIG. 10A illustrates an example of the account deposit/withdrawal database 406. The account deposit/withdrawal database 406 contains data such as an inquiry number, transaction date, deposit amount, withdrawal amount, name of the partner, code of the account bank of the partner, and the remittance number of the account bank, for each account. Here, the inquiry number is the remittance number at the account bank of the remittee, and the partner is the remitter or remittee.

After the remittance result data is received, the program 401 searches for a record that contains data coinciding with the remittance number, code of the account bank of the remitter, code of the account bank of the remittee and account number at the account bank of the remittee that are included in the remittance result data. The program 401 then extracts records for the account number at the account bank of the remittee from the account deposit/withdrawal database 406, and searches for data from among the extracted records that coincides with the remittance number and code of the account bank of the remittee. According to that search result, the program 401 determines whether or not corresponding deposit data is stored (S202). When corresponding deposit data is not stored, the received remittance result data is deleted (S203). On the other hand, when a corresponding record is found, as shown in FIG. 10B, the program 401 adds a URL and password to the record to correlate the remittance number, which is contained in the received remittance result data, the URL and the password with the record (S204). In the example shown in FIG. 10B, the URL, ‘http://www.hh.com/soukin.cgi?’, and the password, ‘abc075def’, are added to the record for which the data for the inquiry number and remittance number is ‘ZZ0098765’ and ‘ZTK13579’.

An account data provision unit 505 provides the contents of the account for which there is an inquiry from the terminal of the customer, to the terminal via the network. One example of the terminal of the customer is the computer 106 at the remittee. As shown in FIG. 1 or FIG. 2, the computer 106 at the remittee is connected with the computer 103 at the account bank of the remittee and the computer 101 at the remitter by way of the Internet 107.

When there is a deposit inquiry from a terminal, a verification unit 506 verifies a user of the terminal based on the code that identifies the customer and data for verifying that person.

Receiving an deposit inquiry from the terminal of a verified user, an access data creation unit 507 creates data for accessing the address indicated by address data based on the ID code, address data and verification data that are contained in the remittance result data, if the remittance result data is correlated with the deposit data sent to the terminal corresponding to the inquiry. The access data creation unit 507 adds the created data to the data that will be sent in correspondence to the inquiry.

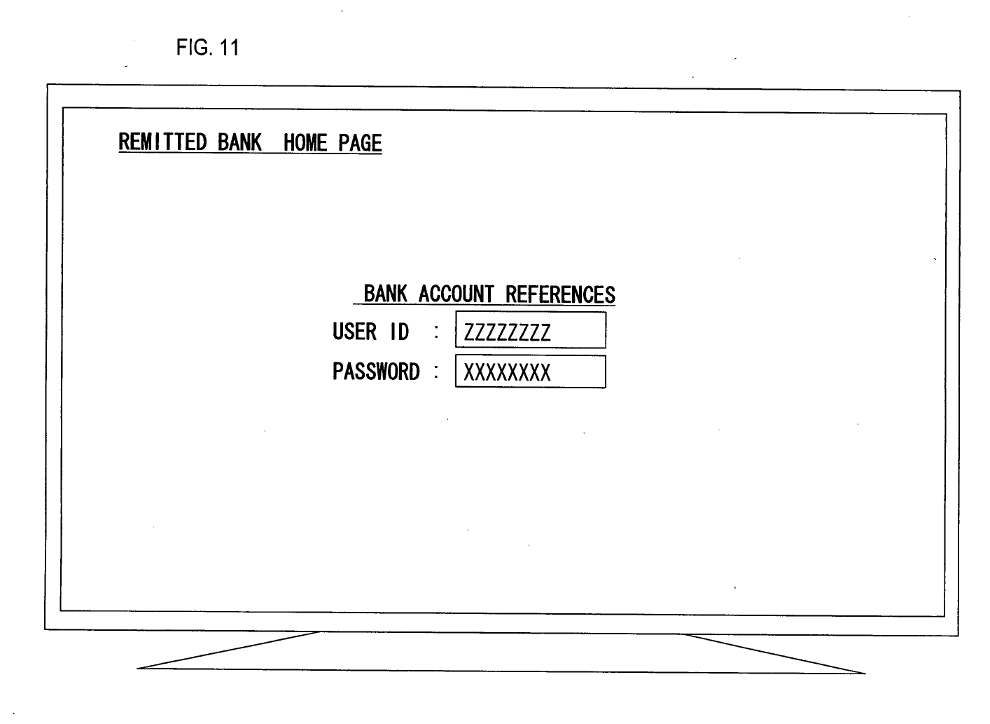

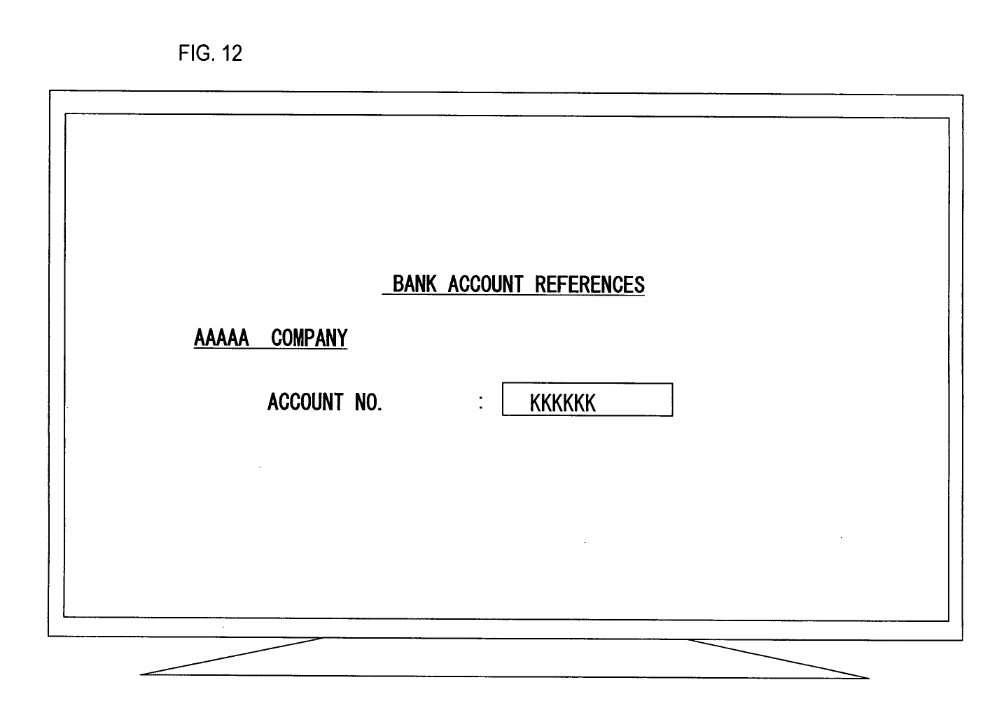

The functions of the web server 407 included in the program 401 can be used for the account data provision unit 505, verification unit 506 and access data creation unit 507. The customer of the bank uses the web browser to inquire about the contents of his or her own account. After the computer 103 receives a connection request for making that inquiry by the communication device 405 (S301 in FIG. 9), the web server 407 requests input from the user ID unique to the customer of the bank and the password registered for the user ID (S302). The web browser displays a form as shown in FIG. 11 for entering the user ID and password. The user ID and password that are entered in this form are sent to the web server 407. After receiving the user ID and password (S303), the web server 407 performs verification by comparing them with the registered user ID and password (S304). In the case where the received user ID and password differ from the registered user ID and password, the web server 407 sends a verification error message to the web browser of the requesting source (S305) and processing ends. However, when they match, the web server 407 sends a web page for requesting input of the account number (S306). A form as shown in FIG. 12 is displayed by the web browser on the terminal used by the customer of the bank. The account number entered in this form is sent to the web server 407. After receiving the account number (S307), the web server 407 gives that account number to the CGI program 408 contained in the program 401. The CGI program 408 sends a request to a search program 409 to search for a record that corresponds to the received account number. The search program 409 searches the account deposit/withdrawal database 406 for a corresponding record, and returns the result to the CGI program 408. When no corresponding record is found (S308), the CGI program 408 creates a web page indicating that there are no records corresponding to the specified account number, and sends the web page to the web browser (S309).

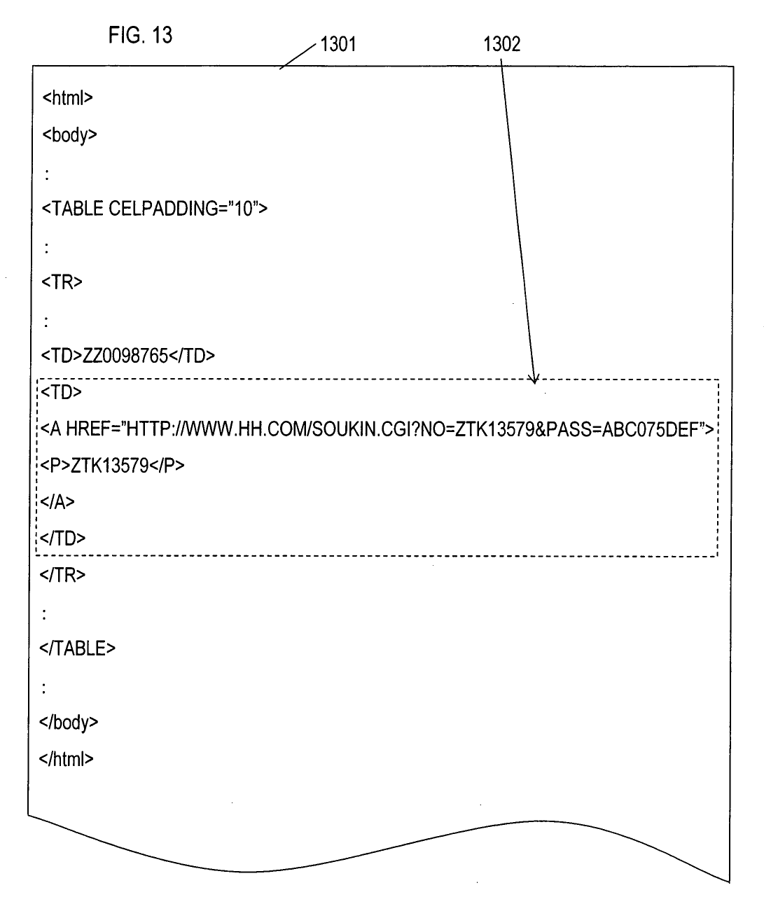

When a corresponding record is found (S308), if the found record contains the URL and password of the remittance result data, the CGI program 408 creates a webpage that contains a link for connecting to the URL, and the web server 407 sends that webpage to the web browser (S310). In the example shown in FIGS. 10A and 10B, the record that is found is a record in which the data for the inquiry number and remittance number is ‘ZZ0098765’ and ‘ZTK13579’, respectively. As described above, this record contains data for the URL, ‘http://www.hh.com/souokin.cgi?’, and password, ‘abc075def’. Using this kind of data, the CGI program creates source data for a webpage as shown in FIG. 13. In this example, access data 1302 that uses the URL data and password mentioned above is added to the data 1301 that is normally provided in correspondence to the inquiry.

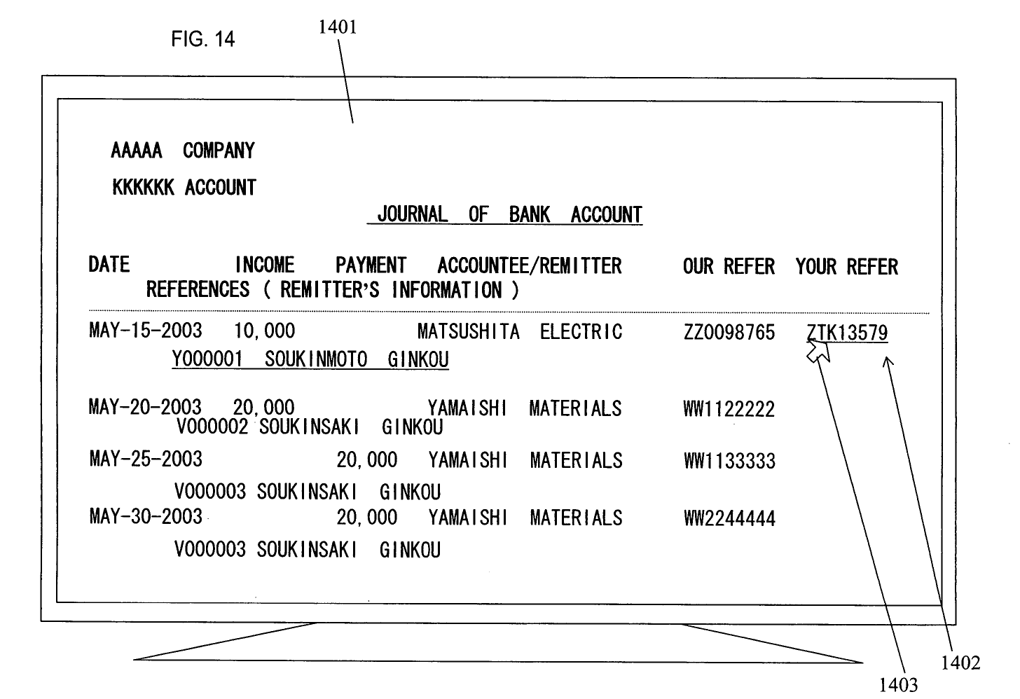

After this webpage is received, the web browser displays the webpage 1401 as shown in FIG. 14. This example also corresponds with the example shown in FIGS. 10A and 10B, with there being a deposit on May 15 and May 20, 2003. For the deposit on May 20, there is no link to corresponding items. However, for the deposit on May 15, there is a link 1402 to corresponding items. The connection destination of this link 1402 is given as the URL contained in the remittance result data to which the remittance number and password have been added. Here, according to the data 1302 shown in FIG. 13, the connection destination is given as ‘http://www.hh.com/soukin?no=ztk13579&pass=abc075def’. Instead of this, the connection destination could also be given as ‘http://www.hh.com/soukin?no=ztk13579&pass=abc075def’. Also, instead of ‘ztk13579’ and ‘abc075def’ that indicate the remittance number and password, it is possible to add a string of codes.

When the link 1402 is selected by using an input device such as a mouse to place the cursor 1403 over the link, the web browser performs an access request to access the computer that sends the remittance result data. Here, that request is sent to the computer 101 at the remitter.

When there is an access request at the computer 101 to access the address of stored detailed data, an access authorization judgment unit 305 determines whether or not to allow access of the detailed data based on the ID code and verification data that is correlated with the address.

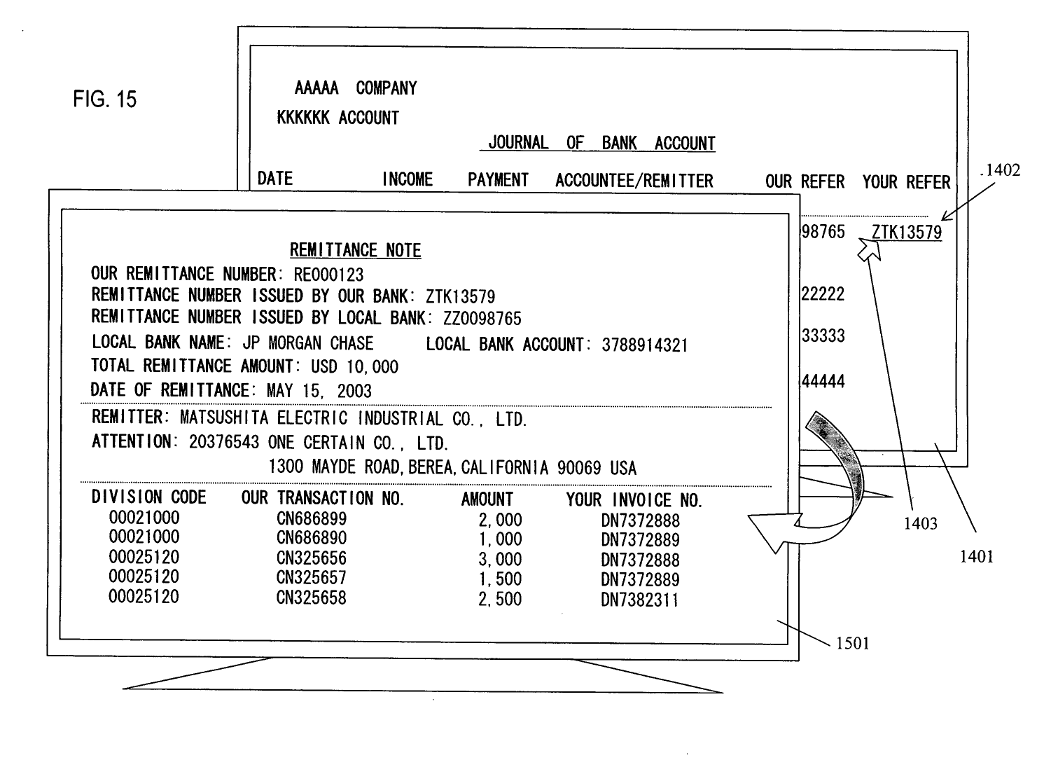

After access is allowed, a detailed data provision unit 306 provides the detailed data to the source requesting the access. Here, as shown in FIG. 15, after the link 1402 is selected on the webpage 1401 and access is allowed, the detailed data provision unit 306 provides a webpage 1501 showing the detailed data.

It is possible to use the program 201 and web server 207 for this kind of access authorization judgment unit 305 and detailed data provision unit 306.

After the computer 101 receives the access request by the communication device 205 (S401 in FIG. 5), the web server 207 acquires the remittance number and password from the request (S402), and gives the acquired remittance number and password to the CGI program 208. The CGI program 208 requests the search program 209 to search for the record that corresponds to the acquired remittance number and password. The search program 209 searches the remittance information database 206 for the corresponding record (S403), and returns the result to the CGI program 208. When the corresponding record is not found (S404), the program 201 determines not to allow access of the detailed data. At that time, the CGI program 208 creates a webpage indicating that there is no detailed data stored at the specified address or that there was an error in the verification data, and the web server 207 sends the webpage to the web browser (S405). When a corresponding record is found (S404), the program 201 determines to allow access of the detailed data. At that time, the CGI program 208 creates a webpage 1401 based on the record that was found (S406), and the web server 207 sends the webpage 1501 to the web browser of the request source (S407). After this webpage 1501 is received, the web browser on the computer 106 displays that webpage 1501.

In the example shown in FIG. 15, ‘OUR REMITTANCE NUMBER’, ‘REMITTANCE NUMBER ISSUED BY OUR BANK’ and ‘REMITTANCE NUMBER ISSUED BY LOCAL BANK’ are remittance numbers for the remitter or account bank, ‘TOTAL REMITTANCE AMOUNT’ is the total remittance amount, ‘DIVISION CODE’ is the code that identifies the domain company, ‘OUR TRANSACTION NO.’ is the management number at the remitter, ‘AMOUNT’ is the remittance amount for each ‘OUR TRANSACTION NO.’, and ‘YOUR INVOICE NO.’ is the invoice number for billing the domain company. This example shows the case where the remittance number is ‘ZTK13759’, and as shown in FIG. 15, the breakdown of the remittance is shown using the division code, the management number, the invoice number, etc.

In the detailed remittance data provision system of the embodiment described above, by selecting the link that is included in the remittance items for which there was an inquiry made by the remitter to the account bank, it is possible to reference detailed data that contains the breakdown for the remittance in an apparatus at the remitter. Also, since it is necessary to receive verification from the bank to access the link, access is difficult for a party other than the remittee. Moreover, when it is not possible to access the link, it is also not possible to acquire the password for accessing the detailed data, so it becomes difficult for a party other than the remitter or remittee to access the detailed data. Furthermore, since the detailed data is provided by an apparatus at the remitter, it is not necessary for the remitter to send the detailed data anywhere other than the terminal at the remittee, and it is easy to make use of data collected within the company in the detailed data.

In this embodiment, a detailed data provision system related to the remittance was explained. However, the invention can also be applied to a detailed data provision system for personal information.

Also, the program 201 or program 401 can be operated on a plurality of computers at the account bank of the remitter or remittee. The program 201 or program 401 can be provided to persons related to the system or a third party by using a telecommunications line such as the Internet, or by storing the program on a computer readable storage medium. For example, by expressing the instructions of the program as electrical, optical or magnetic signals, and then sending those signals on a carrier wave, it is possible to provide the program via a communications line that uses copper wire or optical fibers. Moreover, an optical medium such as a CD-ROM or DVD-ROM, a magnetic medium such as a floppy disk, or a semiconductor memory such as a flash memory or RAM can be used as the computer readable storage medium.

The detailed data provision system of this invention makes it possible for a person who received basic data provided by an intermediary to easily reference detailed data that corresponds to the basic data, and is effective in making it possible to maintain confidentiality of the detailed data, and thus can be used for providing detailed information such as in the case of providing a remittee with details of the remittance information that was sent to the account bank of the remittee.

The disclosure of Japanese Patent Application No. 2003-380943 filed Nov. 11, 2003 including specification, drawings and claims is incorporated herein by reference in its entirety.

The embodiment described above does not limit the technical scope of the invention, and in addition to the embodiments described above, the embodiments can be modified or applied in various ways within the scope of the invention.

1. A detailed data provision system including detailed data provision apparatus for providing detailed data of basic data sent to apparatus of an intermediary to a terminal of a recipient, said apparatus of the intermediary providing data corresponding to the basic data to the terminal of the recipient, said detailed data provision apparatus comprising:
a unit configured to store detailed data;
a unit configured to correlate an ID code for the basic data, address data indicating an address of the detailed data corresponding to the basic data, and verification data for verifying an access source accessing the detailed data;
a unit configured to send transmission result data to the apparatus of the intermediary receiving the basic data, said transmission result data including the ID code for the basic data and including the address data and verification data correlated with the basic data;
a unit configured to, in response to a request to access the address of the stored detailed data, determine whether or not to authorize access of the detailed data according to the ID code and verification data correlated with the address; and
a unit configured to provide the authorized detailed data to a source of the request.

2. The detailed data provision system of claim 1, said apparatus of the intermediary comprising:
a unit configured to store providing data corresponding to the basic data;
a unit configured to correlate the transmission result data with the providing data, upon said providing data being stored and corresponding to the ID code included in the transmission result data received;
a unit configured to, in response to a connection request from a terminal, verify a user of the terminal; and
a unit configured to, in response to a request from the terminal of the verified user, upon the transmission result data being correlated with data provided to the terminal according to the request, create data for accessing the address indicated by the address data based on the ID code, address data and verification data included in the transmission result data, and add the created data to the data provided according to the request.

3. The detailed data provision system of claim 2 wherein
the basic data is data related to a remittance;
the transmission result data is remittance result data including an ID code for the remittance and including address data and verification data correlated with the ID code;
the detailed data provision apparatus is apparatus of a remitter;
the terminal of the recipient is a terminal of a remittee;
the apparatus of the intermediary is apparatus of an account bank of the remittee; and
the providing data is deposit data.

4. The detailed data provision system of claim 3 wherein
the remittance result data includes an ID code for an account bank of the remitter, an ID code for the account bank of the remittee and the account number at the account bank of the remitter in addition to an ID code for a remittance, and address data and verification data correlated with the ID code for the remittance; and
the apparatus of the account bank, in case of said deposit data being stored and corresponding to the ID code for the remittance, ID code for the account bank of the remitter, ID code for the account bank of the remittee and the account number at the account bank of the remittee included in the transmission result data received, correlates an ID number for the remittance, address data and verification data included in the remittance result data with the deposit data.

5. A detailed data provision method for providing detailed data of basic data sent to apparatus of an intermediary to a terminal of a recipient, said apparatus of the intermediary providing data corresponding to the basic data to the terminal of the recipient, said detailed data provision method comprising the steps of:
correlating an ID code for the basic data, address data indicating an address of the detailed data corresponding to the basic data, and verification data for verifying an access source accessing the detailed data;
sending transmission result data to the apparatus of the intermediary receiving the basic data, said transmission result data including the ID code for the basic data and including the address data and verification data correlated with the basic data;
determining, in response to a request to access an address of stored detailed data, whether or not to authorize access of the detailed data according to the ID code and verification data correlated with the address; and
providing the authorized detailed data to a source of the request.

6. A computer readable medium bearing a program for causing a computer to execute the steps of the detailed data provision method of claim 5.

7. A program for causing a computer to execute the steps of the detailed data provision method of claim 5.
